(19) United States
(12) Patent Application Publication
(10) Pub. No.: US 2023/0343153 A1
(43) Pub. Date: Oct. 26, 2023

(54) METHOD AND SYSTEM FOR TESTING A DRIVER ASSISTANCE SYSTEM

(71) Applicant: AVL LIST GMBH, Graz (AT)

(72) Inventors: Thomas SCHLÖMICHER, Graz (AT); Ziya ERCAN, Istanbul (TR)

(21) Appl. No.: 18/245,457

(22) PCT Filed: Sep. 10, 2021
(86) PCT No.: PCT/AT2021/060321

§ 371 Date: Mar. 15, 2023

(30) Foreign Application Priority Data
Sep. 15, 2020 (AT) A50781/2020

(51) Int. Cl. G07C 5/08; B60W 50/06; B60W 40/10

(52) U.S. Cl. CPC G07C 5/0816; B60W 50/06; B60W 40/10; B60W 2554/4041; B60W 2552/10; B60W 2420/42; B60W 2556/40; B60W 2420/52

(57) ABSTRACT

The invention relates to a computer-implemented method for testing a driver assistance system of an ego vehicle on the basis of test drive data and a corresponding system, comprising: assigning attributes to other vehicles captured in the test drive data and located in the immediate surroundings of the ego vehicle, where the attributes specify respective relative positions of the other vehicles in relation to the ego vehicle at a point in time within the test drive data and the attributes are associated with an associated time point; checking the test drive data for an occurrence of elementary lateral maneuvers that are characterized by a change in position of the ego vehicle or one of the other vehicles perpendicular to the course of the road, and elementary longitudinal maneuvers that are characterized by a change in the distance of a vehicle driving in front of and/or behind the ego vehicle or one of the other vehicles, where the occurrence of elementary maneuvers is associated with an associated point in time; identifying an occurrence of predefined scenarios based on the elementary maneuvers having occurred; and analyzing the driving behavior of the driver assistance system in the identified scenarios.

The invention relates to a computer-implemented method for testing a driver assistance system of an ego vehicle on the basis of test drive data.

There is an ever increasing proliferation of driver assistance systems (Advanced Driver Assistance Systems—ADAS) in both the passenger car as well as the commercial vehicle sectors. Driver assistance systems make an important contribution to increasing active traffic safety and serve in enhancing driving comfort.

In addition to systems which serve in particular driving safety such as ABS (anti-lock braking system) and ESP (electronic stability program), a plurality of driver assistance systems are touted in the passenger and commercial vehicle sectors such as, for example, park assist, adaptive cruise control, lane assist and others. These driver assistance systems not only increase safety in traffic by warning the driver of critical situations but also initiate autonomous intervention to prevent accidents or mitigate the consequences of an accident, for example by activating an emergency braking function. Additionally, functions like automatic parking, automatic lane-keeping and automatic proximity control increase driving comfort.

An assistance system's gains in safety and comfort are only perceived positively by the vehicle's occupants when the aid provided by the driver assistance system is safe, reliable and—to the extent possible—convenient.

Moreover, every driver assistance system, depending on its function, needs to handle given traffic scenarios with maximum safety for the vehicle itself and without endangering other vehicles or other road users respectively.

This results in the need to analyze and optimize a driver assistance system or, respectively, the driving behavior generated by the driver assistance system.

Document WO 2015/032508 relates to a method for optimizing at least one driver assistance system which comprises the following procedural steps:
checking whether the at least one driver assistance system A is activated;
detecting at least one vehicle parameter function suitable for characterizing a vehicle's operating state and/or at least one environmental parameter function suitable for characterizing the vehicle's surroundings;
determining at least one driving situation characteristic function which characterizes driving situations of the vehicle, particularly at least on the basis of the at least one vehicle parameter function and/or the at least one environmental parameter function;
determining at least one control intervention characteristic function suitable for characterizing the activity of the at least one driver assistance system A; and
determining a correction function which depends on the at least one control intervention characteristic function and the at least one driving situation characteristic function and is particularly suitable for characterizing at least one vehicle occupant's subjective perception of the activity of the driver assistance system A on the basis of the at least one vehicle parameter function and/or the at least one environmental parameter function.

One task of the invention is that of specifying an improved method for testing a driver assistance system. Particularly a task of the invention is that of improving determination of the driving situation occurring during a test drive within the scope of a driver assistance system test.

This task is solved by the teaching of the independent claims. Advantageous embodiments are claimed in the dependent claims.

A first aspect of the invention relates to a computer-implemented method for testing a driver assistance system of an ego vehicle on the basis of test drive data, said method comprising the following procedural steps:
assigning attributes to other vehicles captured in the test drive data and located particularly in the immediate surroundings of the ego vehicle, wherein the attributes specify respective relative positions of the other vehicles in relation to the ego vehicle at a point in time within the test drive data and wherein the attributes are associated with an associated time point;
checking the test drive data for an occurrence of elementary lateral maneuvers, characterized in each case by a change in position of the ego vehicle or one of the other vehicles perpendicular to the course of the road, and elementary longitudinal maneuvers, characterized in each case by a change in the distance of a vehicle driving in front of and/or behind the ego vehicle or one of the other vehicles, particularly in the same lane, wherein the elementary maneuvers are selected from a list of predefined elementary maneuvers and wherein the occurrence of elementary maneuvers is also associated with at least one associated point in time;
identifying an occurrence of predefined scenarios based on the elementary maneuvers having occurred, wherein the predefined scenarios are characterized by a constellation of elementary maneuvers and attributes; and
analyzing the driving behavior of the driver assistance system in the identified scenarios.

A second aspect of the invention relates to a system for the functional testing of an ego vehicle's driver assistance system on the basis of test drive data, which comprises:
means for assigning attributes to other vehicles captured in the test drive data and located particularly in the immediate surroundings of the ego vehicle, wherein the attributes specify respective relative positions of the other vehicles in relation to the ego vehicle at a point in time within the test drive data and wherein the attributes are associated with an associated time point;
means for checking the test drive data for an occurrence of elementary lateral maneuvers, characterized in each case by a change in position of the ego vehicle or one of the other vehicles perpendicular to the course of the road, and elementary longitudinal maneuvers, characterized in each case by a change in the distance to a vehicle driving in front of and/or behind the ego vehicle or one of the other vehicles, particularly in the same lane, wherein the elementary maneuvers are selected from a list of predefined elementary maneuvers and wherein the occurrence of elementary maneuvers is also associated with at least one associated point in time;
means for identifying an occurrence of predefined scenarios based on the elementary maneuvers having occurred, wherein the predefined scenarios are characterized by a constellation of elementary maneuvers and attributes; and
means for analyzing the driving behavior of the driver assistance system in the identified scenarios.

Further aspects of the invention relate to a computer program product containing instructions which, when executed by a computer, prompt it to execute the steps of a method according to the first aspect of the invention as well as a computer-readable medium on which such a computer program product is stored.

Within the meaning of the invention, testing a driver assistance system serves in analyzing or optimizing the driver assistance system or the driving behavior of the driver assistance system. This can occur on the road in driving operation or also within particularly a virtual environment in the development process.

Means within the meaning of the invention can be configured as hardware and/or software and in particular comprising a processing unit, particularly a digital processing unit, preferably data-connected or signal-connected to a memory or bus system, in particular having a microprocessor unit (CPU) and/or one or more programs or program modules. The CPU can thereby be designed to process commands implemented as a program stored in a memory system, detect input signals from a data bus and/or send output signals to a data bus. A memory system can comprise one or more, in particular different, storage media, particularly optical, magnetic solid-state and/or other non-volatile media. The program can be provided so as to embody or be capable of performing the methods described herein such that the CPU can execute the steps of such methods and can thus in particular analyze a vehicle to be tested.

A scenario within the meaning of the invention is preferably formed by a chronological sequence of spatial, in particular static, scenes. The spatial scenes thereby preferably indicate the spatial arrangement of at least one other object relative to the ego vehicle, e.g. the constellation of road users or static objects such as lane markings. A scenario can in particular include a driving situation in which a driver assistance system at least partly controls the vehicle known as the ego vehicle and equipped with the driver assistance system, e.g. autonomously executes at least one vehicle function of the ego vehicle.

A lane or traffic lane within the meaning of the invention is preferably a pavement, in particular a traffic lane on a road surface, which is intended for travel in a specified direction. Preferably, the lane or traffic lane exhibits a marking.

An elementary maneuver within the meaning of the invention is preferably an elementary lateral maneuver, an elementary longitudinal maneuver and/or an elementary cornering maneuver.

An elementary lateral maneuver within the meaning of the invention is preferably a driving maneuver in transverse direction to the course of an ego vehicle's path of travel.

A longitudinal maneuver within the meaning of the invention is preferably a driving maneuver at least substantially in the direction of the ego vehicle's path of travel.

An elementary cornering maneuver within the meaning of the invention is preferably a driving maneuver in which an ego vehicle's trajectory depicts a curve.

Test drive data within the meaning of the invention preferably relates to values, in particular data sets, of parameters which characterize the surroundings and/or the operation of an ego vehicle during a test drive.

A vehicle within the meaning of the invention is preferably a road user, thus in particular an object moving in traffic.

Driving behavior within the meaning of the invention is characterized preferably by driving characteristics of the driver assistance system. In particular, the driving behavior is characterized by the actions of the driver assistance system within its environment and the reactions of the driver assistance system to its environment.

The invention is based on the approach of implementing a scenario-based assessment for validating and verifying the functions of a driver assistance system. In such a scenario-based assessment, the driving behavior of driver assistance systems in specific scenarios is observed, analyzed and/or evaluated.

The inventive teaching achieves this by test drive data of an ego vehicle, preferably captured during a real driving operation, being structured and thereafter searched for elementary maneuvers in scenarios. The data fields of the test drive data corresponding to predefined scenarios relevant to the driver assistance system to be tested are analyzed. The inventive method enables particularly reliable identification of the relevant data fields for the respective driver assistance system to be tested. This in turn leads to a particularly high-quality test result. Furthermore, a set of test drive data from a vehicle can be used repeatedly to test different versions of a driver assistance system and/or other driver assistance systems. This thereby enables significantly reducing the number of real or virtual test drives required to generate test drive data. Particularly with respect to real test drive data, the mileage required to generate such test drive data, which is normally undertaken by a real driver, can be significantly reduced.

Moreover, the inventive method provides a test engineer with a high degree of flexibility when evaluating test drive data relative to a specific function. In particular, it is possible for the test engineer to define an unlimited number of different scenarios for which test drive data can be searched. This enables the creating of scenarios best suited to testing a specific function of a driver assistance system. Also, that test drive data which is best suited to an analysis of the driving behavior of the respective driver assistance system can be identified from among a series of test drives.

In one advantageous embodiment of the method, the test drive data is searched exclusively for those attributes and/or elementary maneuvers contained in the predefined scenarios.

This embodiment enables significantly reducing the checking of the test drive data in terms of computing capacity and/or computing time since the search only encompasses potentially relevant data fields of the test drive data.

In a further advantageous embodiment of the method, test runs are conducted on a test bed using the test drive data in order to analyze the driving behavior of the driver assistance system in the identified scenarios. Preferably, the test bed is a vehicle test bed, a vehicle-in-the-loop test bed, a hardware-in-the-loop test bed or a software-in-the-loop test bed.

This embodiment enables particularly high quality to be achieved in the analysis, evaluation and/or optimization of the driving behavior of a driver assistance system.

In a further advantageous embodiment, the test drive data is checked for the occurrence of elementary maneuvers using machine learning-trained models of the elementary maneuvers.

In particular, patterns for recognizing elementary maneuvers in test drive data are used when checking for elementary maneuvers, these having been generated by machine learning on the basis of test drive data which has already been classified with respect to maneuvers. Preferably, test drive data is thereby human-classified and the data then imported into a machine learning algorithm, particularly an artificial neural network.

One advantage of this embodiment is that it is the elementary maneuvers and not the scenarios themselves which are trained in a machine learning model process. This provides a high degree of flexibility as regards defining new scenarios since they can be modularly compiled from the individual patterns or respectively models of the elementary maneuvers. In principle, customized scenarios can in this way be compiled for each application.

In a further advantageous embodiment of the method, the list includes at least one of the following elementary lateral maneuver groups: lane change to left, lane change to right, in-lane driving, out-of-lane driving, veer to right, veer to left.

In a further advantageous embodiment of the method, the list includes at least one of the following elementary longitudinal maneuver groups: initial start, gap opening, gap closing, vehicle following, clear-lane driving, stopping.

In a further advantageous embodiment of the method, the test drive data is furthermore checked for an occurrence of elementary cornering maneuvers and the elementary cornering maneuvers are selected from a list which includes at least one of the following elementary cornering maneuver groups: straight-line travel without curvature, cornering with increasing absolute curvature, exiting cornering with decreasing absolute curvature, cornering at constant curvature, left turning, right turning, traffic circle driving.

Inclusion of cornering maneuvers in the elementary maneuvers enables an even more differentiated classification of the test drive data.

In a further advantageous embodiment of the method, the attributes indicate whether another vehicle is located in the same lane or in a right or left lane in relation to the ego vehicle and whether the other vehicle is located in front of, behind or even with the ego vehicle in relation to the course of a road. This thereby allows other road users to be clearly identified.

In a further advantageous embodiment of the method, the attributes furthermore indicate which vehicle in a lane is the other vehicle with respect to the ego vehicle.

In a further advantageous embodiment of the method, the attributes furthermore indicate the direction in which the other vehicle is driving in relation to the direction of travel of the ego vehicle.

In a further advantageous embodiment of the method, the attributes are independent of the distance of the other vehicle relative to the ego vehicle but are only assigned up to a defined distance within a measuring range of a sensor for determining the ego vehicle attributes. As a result, the information contained in the test drive data is reduced to that information which is actually relevant for defining elementary driving maneuvers.

This thereby enables faster data processing and/or requires less computing power.

In a further advantageous embodiment of the method, the test drive data is generated on the basis of real test drive data, and a lane of the ego vehicle and the other vehicles is determined by means of an intelligent camera which is preferably mounted on the ego vehicle.

In a further advantageous embodiment of the method, a known position of landmarks in relation to a reference system, in particular a high-resolution map captured by the intelligent camera, is furthermore used to determine the lane of the ego vehicle and the other vehicles.

The use of an intelligent camera enables a particularly differentiated analysis of the test drive data.

In a further advantageous embodiment of the method, the test drive data is generated on the basis of real test drives, and relative positions of the other vehicles in relation to the ego vehicle are determined by means of an intelligent camera, lidar and/or radar, preferably mounted in each case in the ego vehicle.

Further features and advantages of the invention are yielded by the following description referencing the figures. Shown therein at least partly schematically:

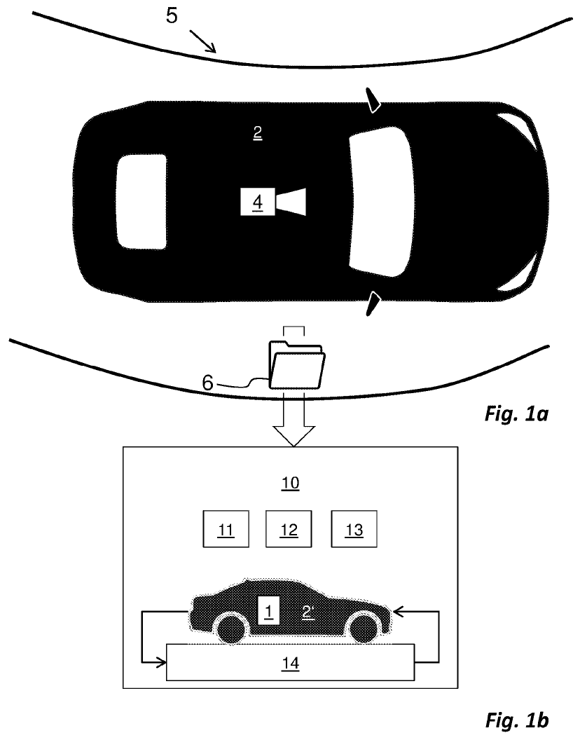

FIG. 1a an ego vehicle on a test drive;

FIG. 1b an exemplary embodiment of a system for testing a driver assistance system;

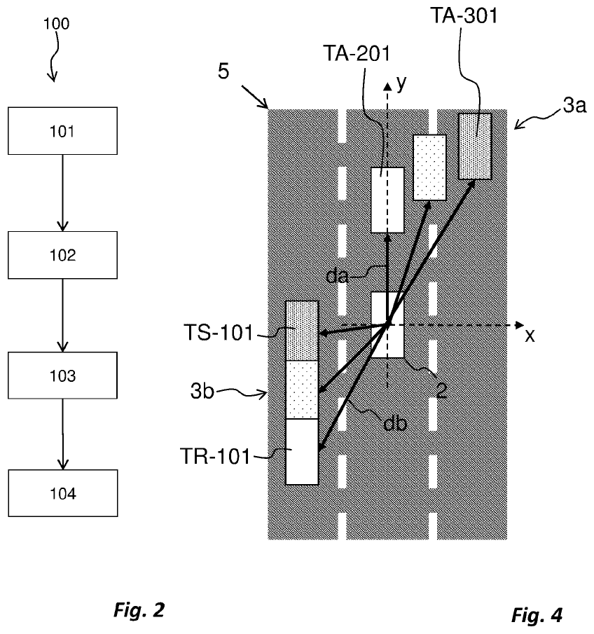

FIG. 2 a flowchart of an exemplary embodiment of a method for testing a driver assistance system;

FIG. 3 a representation of attributes of other vehicles;

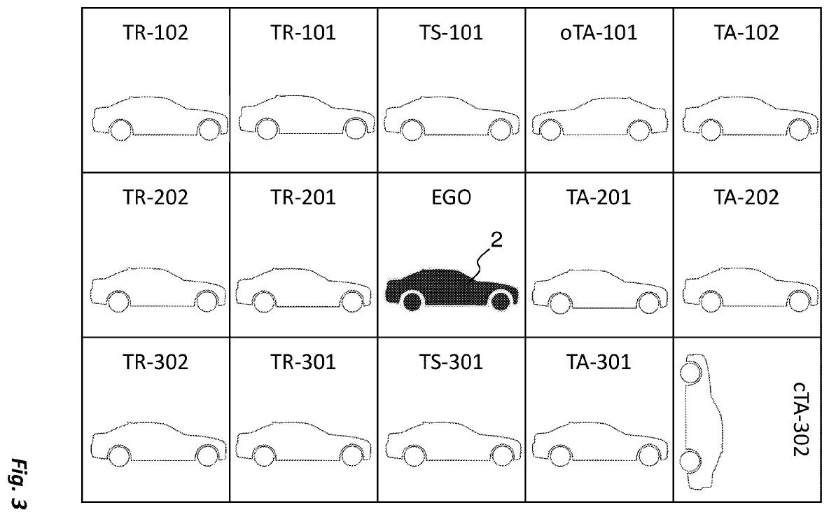

FIG. 4 a representation of a dynamic development of the attributes of other vehicles; and

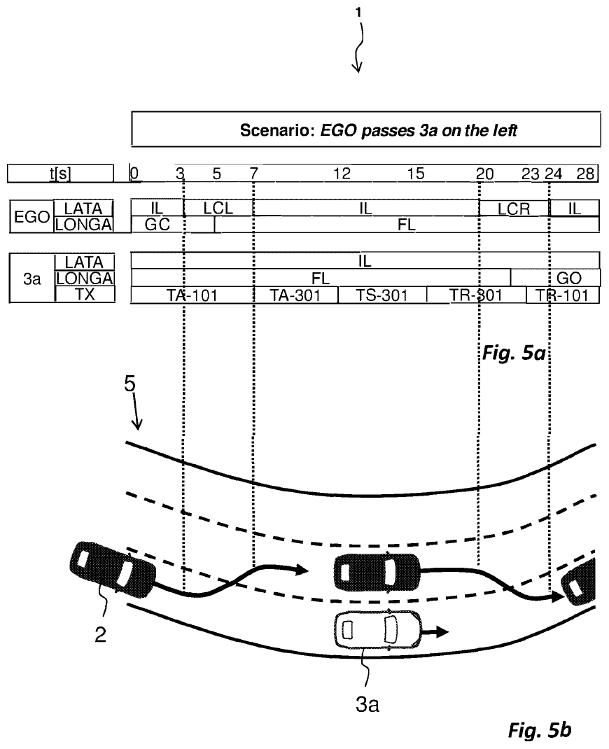

FIG. 5a a diagram depicting the chronological sequence of a passing maneuver by an ego vehicle; and

FIG. 5b a graphical representation of the FIG. 5a passing maneuver.

FIG. 1a shows a vehicle 2 during a test drive on a road 5.

During the test drive, the vehicle 2 collects test drive data 6 as the ego vehicle serving as a reference in the traffic situation. The ego vehicle 2 preferably has a plurality of sensors to that end which record the traffic situation and the environment around the vehicle. FIG. 1a shows, purely as an example, the ego vehicle 2 having a camera 4, particularly an intelligent camera. Preferably, such a camera 4 has a field of view of 360° in order to monitor the entire environment around the ego vehicle 2. Further possible sensors include radar, lidar, ultrasound, etc. An intelligent camera 4 is able to, for example, recognize other lanes and associate other road users with lanes as well as recognize traffic signs and landmarks which can serve in determining the exact location of the ego vehicle 2, for example in conjunction with a high-resolution map. Furthermore, the ego vehicle preferably has a data storage unit (not depicted) configured to store the test drive data 6 collected by the intelligent camera 4 and any other sensors there may be. In FIG. 1a, the test drive data is represented by the file folder 6.

So-called OSI documentation is in particular used to encode the test drive data 6. OSI stands for Open Simulation Interface and is a generic interface for the environmental perception of automated driving functions in virtual scenarios (https://opensimulationinterface.github.io/osi-documentation/).

During the test drive (online) or after the test drive (post mortem), the test drive data 6 is provided to a system 10 for testing a driver assistance system, which is indicated by the arrow pointing from FIG. 1a to FIG. 1b.

FIG. 1b shows the system 10 for testing a driver assistance system.

The system 10 preferably serves in evaluating the collected test drive data 6 and in analyzing the driving behavior which a driver assistance system 1 would have exhibited during a test drive in which the test drive data 6 was generated.

The system 10 according to FIG. 1b is in particular configured to implement a method 100 for testing a driver assistance system 1 in accordance with FIG. 2.

The means 11 for assigning attributes Tx-yyy, the means 12 for checking the test drive data 6, and the identification means 13 are thereby preferably means of a data processing system configured so as to realize their respectively assigned function.

The means 14 for analyzing the driving behavior can also be implemented in a data processing system. Preferably provided in this case is also simulating the driver assistance system 1 or only checking its software, particularly via a software-in-the-loop method.

Further preferably, however, the means 14 for analyzing the driving behavior of the driver assistance system 1 is designed as a test bed, in particular a vehicle test bed, vehicle-in-the-loop test bed or hardware-in-the-loop test bed.

Preferably, the driver assistance system 1 is installed on or connected to such a test bed 14 and data fields of the test drive data 6 which correspond to identified scenarios are made available to the driver assistance system 1 or to the sensors supplying information to the driver assistance system 1 via suitable interfaces. This is indicated in FIG. 1b by an arrow.

In the case of an intelligent camera 4, such an interface can be one or more screens which show the camera 4 the environment around the vehicle based on the data field of the test drive data 6 corresponding to a scenario. In the case of a radar, such an interface could be a radar target emulator, for example. Alternatively, it can also be provided for the test drive data 6 to be further processed so as to be able to be directly provided to a sensor chip of the driver assistance system 1 or also only to the software of said sensor chip.

Preferably, a reaction or action characterizing the driving behavior of the driver assistance system 1 is in turn provided to the test bed 14 via a further interface, as indicated by the further arrow in FIG. 1b.

The test bed 14 is capable of analyzing the driving behavior on the basis of parameters, e.g. control signals output by the driver assistance system 1 or the control of a vehicle 2′ on the test bed 14 effected by the driver assistance system 1.

In particular, it can be provided for the recorded driving behavior of the driver assistance system 1 to be compared to reference data.

Alternatively to the exemplary embodiment of the system 10 for testing the driver assistance system 1 shown in FIG. 1b, which is arranged external of the ego vehicle 2, this system 10 can also be arranged in the ego vehicle 2, for example when the driver assistance system 1 is also directly arranged in the ego vehicle 2 generating the test drive data and the test drive data 6 is directly provided by its local sensors, in particular the intelligent camera 4.

FIG. 2 is an exemplary embodiment of a computer-implemented method for testing the driver assistance system 1 which is in particular able to be implemented by the system 10 shown in FIG. 1b.

In a first procedural step, attributes Tx-yyy which were recorded during a test drive of the ego vehicle 2 and are thus contained in the test drive data are assigned to other vehicles. In the Tx-yyy reference symbol, x thereby signifies the letters R, S and A for “rear”, “side” and “ahead”. The “y” symbols in each case stand for a number which indicates the lane and its location in the direction of travel with respect to the ego vehicle 2.

An example assignment of attributes Tx-yyy to other road users is shown in FIG. 3. Each row of the matrix shown therein preferably corresponds to a lane, whereby the ego vehicle 2 pictured in black is therefore located in the center lane.

Each road user surrounding the ego vehicle 2 is identified by an attribute starting with T. The letters “R,” “S” and “A” stand for “located to the rear,” “located to the side” and “located in front.” The first digit after the hyphen indicates whether the other road users are situated in the same lane or in a different lane. In the exemplary embodiment depicted, number “1” signifies the lane located to the right of the ego vehicle 2, number “2” signifies the lane in which the ego vehicle 2 is located, and number “3” signifies the lane located to the left of the ego vehicle 2. In the exemplary embodiment shown, the last two digits after the hyphen stand for the lane position of the road users ahead of or behind the depicted road user, in this exemplary embodiment a vehicle.

The attributes Tx-yyy are preferably assigned independently of the respective distance of the other road users from the ego vehicle 2.

The assigned attributes Tx-yyy each reflect the relative position of another road user at a point in time of the test drive data 6. Thus, for each increment of time in which data is stored in the test drive data 6, the attribute of the other included road users is preferably also stored. Alternatively, for data reduction purposes, only one change to an attribute Tx-yyy can thereby be saved at a time.

Preferably, attributes Tx-yyy are only assigned up to a defined distance from the ego vehicle 2. Further preferably, this distance is within a measuring range of the sensor(s) detecting the relative position of the other road users to the ego vehicle 2. Preferably, as previously explained, this can be an intelligent camera 4.

The attributes Tx-yyy can furthermore contain information about which direction another road user is moving in relation to the ego vehicle 2. An additional letter can for example thereby be added at the beginning of the attributes. For example, as FIG. 3 shows, the letter “o” (for “opposing”) can identify an oncoming vehicle by means of the oTA-101 attribute and the letter “c” (for “crossing”) can identify a cross-traffic vehicle by means of the cTA-302 attribute.

The FIG. 4 illustration depicts an example chronological progression of attributes Tx-yyy of the road users 3a, 3b. The ego vehicle 2 is located in the center lane.

The first road user 3a changes lanes from the center lane to the right lane, whereby the road user 3a is driving at a higher speed than the ego vehicle 2. The Tx-yyy attribute of road user 3a therefore changes from TA-201 to TA-301.

The second road user 3b is driving behind the ego vehicle 2 in a lane to the left of the lane of the ego vehicle 2 and is about to pass the ego vehicle 2 as it is likewise moving at a higher speed than the ego vehicle 2. Correspondingly, the attribute of the second road user 3b changes from TR-101 to TS-101 at a later point in time when the second road user 3b is even with the ego vehicle 2.

As already clarified, the distance da of the first road user 3a and the distance db of the second road user preferably have no influence on the assignment of the attributes Tx-yyy. Important with respect to the second road user 3b, however, is that he moves from a position rearward of the ego vehicle 2 to a position located on the side and the first road user 3a moves from the center lane to the right lane.

In a second step 102 of the method 100 according to FIG. 2, the test drive data is checked for an occurrence of elementary maneuvers. This check substantially constitutes a search of the test drive data 6 for known patterns of elementary lateral maneuvers LCL; LCR; IL and elementary longitudinal maneuvers GO; GC; FL. Furthermore, a search is preferably conducted for elementary cornering maneuvers. The prerequisite here being that patterns or models are defined for the respective elementary maneuvers which are able to be compared to parameter profiles and parameter constellations contained in the test drive data 6. Such patterns can be stored for example as models. Preferably, these models can be generated using machine learning, wherein the model is in this case preferably trained using test drive data which has already been classified with respect to elementary maneuvers. Preferably, supervised machine learning is thereby used in which test drive data is human-classified and an algorithm, e.g. an artificial neural network, then trained on the basis of this data.

The patterns generated in this way are preferably stored in a list as predefined elementary maneuvers and compared to the test drive data 6 in the checking 102 procedural step.

Example elementary lateral maneuvers are “lane change to left” LCL, “lane change to right” LCR, “in-lane driving” IL, “out-of-lane driving,” “veer to right,” “veer to left.”

Example elementary longitudinal maneuvers are “initial start,” “gap opening” GO, “gap closing” GC, “vehicle following,” “clear-lane driving” FL, “stopping.”

Example elementary cornering maneuvers are “straight-line travel without curves,” “cornering with increasing absolute curvature,” “exiting cornering with decreasing absolute curvature,” “cornering at constant curvature,” “left turning,” “right turning” and “traffic circle driving.”

Referring to FIG. 4, the second road user 3b is in the clear-lane FL elementary longitudinal maneuver and the in-lane driving IL elementary lateral maneuver. In contrast, during the depicted elementary lateral maneuver period, the first road user 3a is initially in the in-lane driving IL elementary lateral maneuver, then the lane change to left LCL elementary lateral maneuver, and lastly back to the in-lane driving IL elementary lateral maneuver. The elementary longitudinal maneuver throughout the entire time period of the first road user 3a depicted is clear-lane driving FL.

In a third procedural step 103, an occurrence of predefined scenarios during the test drive is identified in the test drive data. The scenarios are thereby preferably made up of a constellation of elementary maneuvers LCL; LCR; IL; GO; GC; FL and attributes Tx-yyy.

There can thereby be scenarios which only take elementary maneuvers LCL; LCR; IL; GO; GC; FL of the ego vehicle 2 into account. Normally, however, scenarios comprise an interaction of the ego vehicle 2 in combination with other road users 3a, 3b.

Examples of such predefined scenarios are entering into a lane in front of another road user 3a, 3b, entering into a lane in front of the ego vehicle, passing another road user 3a, 3b, the ego vehicle 2 being passed by another road user 3a, 3b, another road user 3a, 3b exiting a lane, the ego vehicle 2 exiting a lane.

The scenarios can preferably be freely defined by test engineers, whereby the attributes Tx-yyy and elementary maneuvers LCL; LCR; IL; GO; GC; FL of the ego vehicle 2 and the other road users 3a, 3b combine into predefined scenarios.

One example of such a scenario, namely a passing maneuver of ego vehicle 2, is shown in the FIG. 5 diagram in a structuring which indicates the respectively given attributes Tx-yyy and elementary maneuvers LCL; LCR; IL, GO; GC; FL as a function of time t. In particular, this diagram shows a change in the elementary longitudinal maneuver GO; GC; FL and elementary lateral maneuver LCL; LCR; IL of the ego vehicle and the change of the elementary longitudinal maneuver GO; GC; FL and elementary lateral maneuver LCL; LCR; IL as well as the respective given attribute Tx-yyy of a first road user 3a, depicted as a vehicle in FIG. 5b, as a function of time t.

If such a constellation or sequence of attributes Tx-yyy and elementary maneuvers LCL; LCR; IL; GO; GC; FL is determined in the test drive data 6 during the analysis, that data field which corresponds to a scenario of an ego vehicle 2 passing maneuver can be identified in the test drive data 6.

The first road user 3a is in the in-lane driving IL elementary lateral maneuver for the entire time of the maneuver.

The ego vehicle 2 is initially in the in-lane driving IL elementary lateral maneuver but starts to overtake at the 3-second time point, whereby a lane change to left LCL is initiated. The lane change ends at time t equal to 7 seconds. From this point in time until time t equal to 20 seconds, the ego vehicle is in the in-lane driving IL elementary lateral maneuver. At time t equal to 20 seconds, the ego vehicle has passed the first road user 3a and again begins to change lanes to the right lane, whereby the lane change to right LCR elementary lateral maneuver is initiated. This ends at time t equal to 24 seconds. The ego vehicle 2 is then back in the right lane and now continues on in the in-lane driving elementary lateral maneuver.

In corresponding manner, the elementary longitudinal maneuvers of the ego vehicle 2 develop over time t. First, the ego vehicle 2 approaches the first road user 3a, this thereby being the gap closing GC elementary longitudinal maneuver. The clear-lane FL longitudinal driving state occurs as a result of the lane change to left LCL elementary lateral maneuver since the center lane has no other road users. This state also continues after the lane change to right LCR again since there is no other road user in the right lane in front of the first road user 3a.

On the other hand, the first road user 3a is initially in the clear-lane driving FL elementary longitudinal maneuver since there is no one in front of him in the right lane. After the ego vehicle 2 enters the lane in front of the first road user 3a subsequent the passing maneuver, the longitudinal driving state changes to gap opening GO at time t equal to 23 seconds since the ego vehicle 2 is moving away from the first road user 3a at higher speed in the same (right) lane.

The attributes assigned to the first road user 3a in relation to the ego vehicle are indicated in the bottom row of the FIG. 5a diagram. The first road user 3a is initially in front of the ego vehicle 2 such that it receives the TA-101 attribute as the first vehicle ahead of the ego vehicle. After the ego vehicle's lane change to the left LCL, the first road user 3a then has the TA-301 attribute since it is in the lane situated to the right of the ego vehicle's lane. As soon as the ego vehicle 2 has reached and passed the first road user 3a when overtaking, the first road user receives the TS-301 attribute since he is next to the ego vehicle 2 in the lane situated to the right of the ego vehicle 2. Once the ego vehicle 2 has passed by completely, the first road user 3a receives the TR-301 attribute since he is behind the ego vehicle 2 in the lane situated to the right of the ego vehicle 2. As soon as the ego vehicle has again entered back into the right lane in the course of the lane change to the right, the first road user 3a receives the TR-101 attribute since he is situated behind the ego vehicle 2 in the same lane.

In a last procedural step 104, the driving behavior of the driver assistance system in the identified scenarios is ultimately tested and analyzed on the basis of the test drive data 6.

To that end, test runs are preferably conducted on the test bed 14 in the identified scenarios, with the driver assistance system 1 and/or a vehicle 2′ on which the driver assistance system 1 is arranged being operated in a test run under conditions dictated by the test drive data 6. In addition to the boundary conditions resulting from the locations of the other road users 3a, 3b in relation to the ego vehicle 2, the test drive data 6 preferably contains the course of the road, legal requirements from road signs, the weather, the topology, etc.

Preferably observed or analyzed in the test runs is how the respective driver assistance system being tested acts or reacts under the given boundary conditions. This driving behavior of the driver assistance system is preferably compared to reference data in order to perform an evaluation and, if necessary, optimize calibration of the driver assistance system 1.

Preferably, the driver assistance system is thereby operated in a test run based exclusively on those data fields of the test drive data 6 in which scenarios which are relevant to the driving behavior of the respectively tested driver assistance system 1 were identified. This thereby enables significantly reducing the time needed for testing a driver assistance system 1, or the length of the test runs required thereto respectively.

As previously explained, a test bed 14 can thereby be designed as a vehicle test bed but also as a test bed on which only essential parts of a vehicle 2′ and/or the driver assistance system 1 are simulated.

The exemplary embodiments described in the foregoing are only examples which are in no way intended to limit the scope of protection, application and configuration of the invention. Rather, the foregoing description is to provide the person skilled in the art with a guideline for implementing at least one exemplary embodiment, whereby various modifications can be made, particularly as regards the function and arrangement of the described components, without departing from the scope of protection resulting from the claims and equivalent combinations of features.

### LIST OF REFERENCE NUMERALS

1 driver assistance system
2, 2′ ego vehicle
3a, 3b other road user
4 camera sensor/camera
5 road
6 test drive data
10 system
11 means for assigning attributes
12 means for checking test drive data
13 means for identifying occurrence of predefined scenarios
14 means for analyzing driving behavior/test bed
CL lane change to left
LCR lane change to right
IL in-lane driving
GO gap opening
GC gap closing
FL vehicle following
Tx-yyy attribute

What is claimed is:

1. A computer-implemented method for testing a driver assistance system of an ego vehicle on the basis of test drive data, comprising the following procedural steps:
assigning attributes to other vehicles captured in the test drive data and located particularly in the immediate surroundings of the ego vehicle, wherein the attributes specify respective relative positions of the other vehicles in relation to the ego vehicle at a point in time within the test drive data and wherein the attributes are associated with an associated time point;
checking the test drive data for an occurrence of elementary lateral maneuvers which are in each case characterized by a change in position of the ego vehicle or one of the other vehicles perpendicular to the course of the road, and elementary longitudinal maneuvers which are in each case characterized by a change in the distance to a vehicle driving in front of and/or behind the ego vehicle or one of the other vehicles, particularly in the same lane, wherein the elementary maneuvers are selected from a list of predefined elementary maneuvers and wherein the occurrence of elementary maneuvers is also associated with at least one associated point in time;
identifying an occurrence of predefined scenarios in the test drive data based on the elementary maneuvers having occurred, wherein the predefined scenarios are characterized by a constellation of elementary maneuvers and attributes; and
analyzing the driving behavior of the driver assistance system, in particular exclusively, in the identified scenarios.

2. The method according to claim 1, wherein the test drive data is searched exclusively for those attributes and/or elementary maneuvers which are contained in the predefined scenarios.

3. The method according to claim 1, wherein test runs are conducted on a test bed using the test drive data in order to analyze the driving behavior of the driver assistance system in the identified scenarios, wherein the test bed is preferably a vehicle test bed, a vehicle-in-the-loop test bed, a hardware-in-the-loop test bed or a software-in-the-loop test bed.

4. The method according to claim 1, wherein patterns, in particular models, for recognizing elementary maneuvers in test drive data which have been generated by machine learning on the basis of test drive data already having been classified with respect to elementary maneuvers are used when checking for elementary maneuvers.

5. The method according to claim 1, wherein the list includes at least one of the following elementary lateral maneuver groups: lane change to left, lane change to right, in-lane driving, out-of-lane driving, veer to right, veer to left.

6. The method according to claim 1, wherein the list includes at least one of the following elementary longitudinal maneuver groups: initial start, gap opening, gap closing, vehicle following, clear-lane driving, stopping.

7. The method according to claim 1, wherein the test drive data is furthermore checked for an occurrence of elementary cornering maneuvers and wherein the elementary cornering maneuvers are selected from a list which includes at least one of the following elementary cornering maneuver groups: straight-line travel without curvature, cornering with increasing absolute curvature, exiting cornering with decreasing absolute curvature, cornering at constant curvature, left turning, right turning, traffic circle driving.

8. The method according to claim 1, wherein the attributes indicate whether another vehicle is located in the same lane or in a right or left lane in relation to the ego vehicle and whether the other vehicle is located in front of, behind or even with the ego vehicle in relation to the course of a road.

9. The method according to claim 1, wherein the attributes are independent of the distance of the other vehicle relative to the ego vehicle but are only assigned up to a defined distance within a measuring range of a sensor for determining the attributes of the ego vehicle.

10. The method according to claim 1, wherein the test drive data is generated on the basis of real test drives and wherein a lane of the ego vehicle and the other vehicles is determined by means of an intelligent camera which is preferably mounted on the ego vehicle.

11. The method according to claim 10, wherein a known position of landmarks in relation to a reference system, in particular a high-resolution map captured by the intelligent camera, is furthermore used to determine the lane of the ego vehicle and the other vehicles.

12. The method according to claim 1, wherein the test drive data is generated on the basis of real test drives and wherein relative positions of the other vehicles in relation to the ego vehicle are determined by means of an intelligent camera, lidar and/or radar, which in each case are preferably mounted on the ego vehicle.

13. A computer program product containing instructions which, when executed by a computer, prompt it to execute the steps of a method according to claim 1.

14. A computer-readable medium on which a computer program product according to claim 13 is stored.

15. A system for testing a driver assistance system on the basis of test drive data of an ego vehicle, comprising:
means for assigning attributes to other vehicles captured in the test drive data and located particularly in the immediate surroundings of the ego vehicle, wherein the attributes specify respective relative positions of the other vehicles in relation to the ego vehicle at a point in time within the test drive data and wherein the attributes are associated with an associated time point;
means for checking the test drive data for an occurrence of elementary lateral maneuvers which are in each case characterized by a change in position of the ego vehicle or one of the other vehicles perpendicular to the course of the road, and elementary longitudinal maneuvers, which are in each case characterized by a change in the distance to a vehicle driving in front of and/or behind the ego vehicle or one of the other vehicles, particularly in the same lane, wherein the elementary maneuvers are selected from a list of predefined elementary maneuvers and wherein the occurrence of elementary maneuvers is also associated with at least one associated point in time;
means for identifying an occurrence of predefined scenarios based on the elementary maneuvers having occurred, wherein the predefined scenarios are characterized by a constellation of elementary maneuvers and attributes; and
means for analyzing the driving behavior of the driver assistance system, in particular exclusively, in the identified scenarios.
